(19) United States
(12) Patent Application Publication
(10) Pub. No.: US 2022/0087340 A1
(43) Pub. Date: Mar. 24, 2022

(54) Religious Hand Garment Assembly

(71) Applicant: Michael Divine, Tempe, AZ (US)

(72) Inventor: Michael Divine, Tempe, AZ (US)

(21) Appl. No.: 17/029,149

(22) Filed: Sep. 23, 2020

(51) Int. Cl. A41D 19/00; A41D 27/08; G10K 3/00

(52) U.S. Cl. CPC A41D 19/0024; A41D 19/0051; A41D 2400/48; G10K 3/00; A41D 27/08

(57) ABSTRACT

A religious hand garment assembly includes a pair of gloves that can be worn on a respective one of a user's hands. A ring is coupled to a respective one of the gloves and a scroll is rotatably integrated into a respective one of the gloves. The scroll is pullable outwardly from the respective glove such that the scroll is visible. A pair of noise makers is each movably coupled to a respective one of the gloves to emit an audible sound when the respective glove is shaken. A feather is coupled to a respective one of the gloves to enhance the ornamental appearance of the respective glove.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hand garment device and more particularly pertains to a new hand garment device for affirming religious beliefs.

### (2) Description of Related Art Including Information Disclosed Under 37 CFR 1.97 and 1.98

The prior art relates to hand garment devices including a shirt for religious ceremonies. The prior art discloses a variety gloves that each has a light emitter being integrated therein.

### BRIEF SUMMARY OF THE INVENTION

An embodiment of the disclosure meets the needs presented above by generally comprising a pair of gloves that can be worn on a respective one of a user's hands. A ring is coupled to a respective one of the gloves and a scroll is rotatably integrated into a respective one of the gloves. The scroll is pullable outwardly from the respective glove such that the scroll is visible. A pair of noise makers is each movably coupled to a respective one of the gloves to emit an audible sound when the respective glove is shaken. A feather is coupled to a respective one of the gloves to enhance the ornamental appearance of the respective glove.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a religious hand garment assembly according to an embodiment of the disclosure.

FIG. 2 is a bottom perspective view of an embodiment of the disclosure.

FIG. 3 is a right side view of an embodiment of the disclosure.

FIG. 4 is a left side view of an embodiment of the disclosure.

FIG. 5 is a back view of an embodiment of the disclosure.

FIG. 6 is a front view of an embodiment of the disclosure.

FIG. 7 is a perspective view of a noise maker of an embodiment of the disclosure.

FIG. 8 is a perspective view of a scroll of an embodiment of the disclosure.

FIG. 9 is a perspective in-use view of an embodiment of the disclosure.

### DETAILED DESCRIPTION OF THE INVENTION

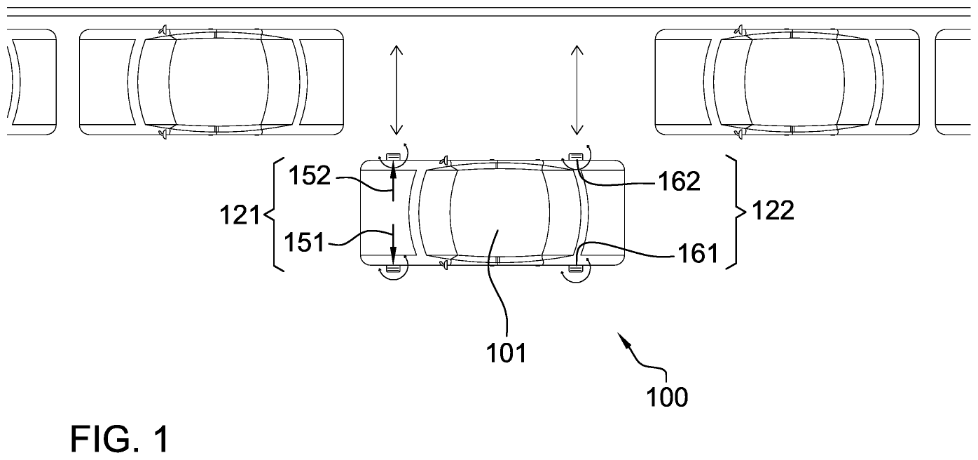

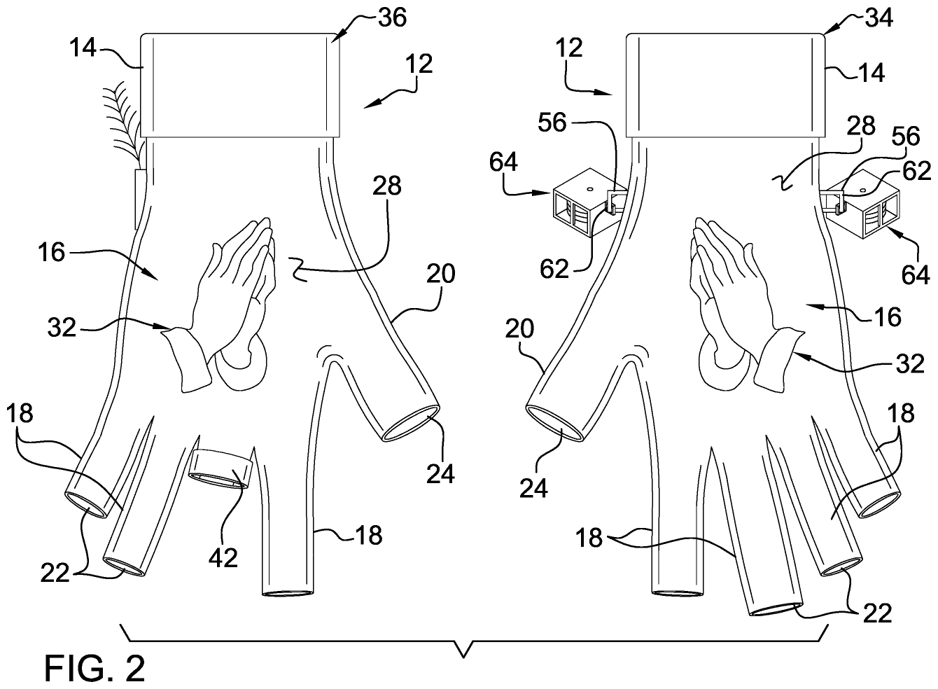

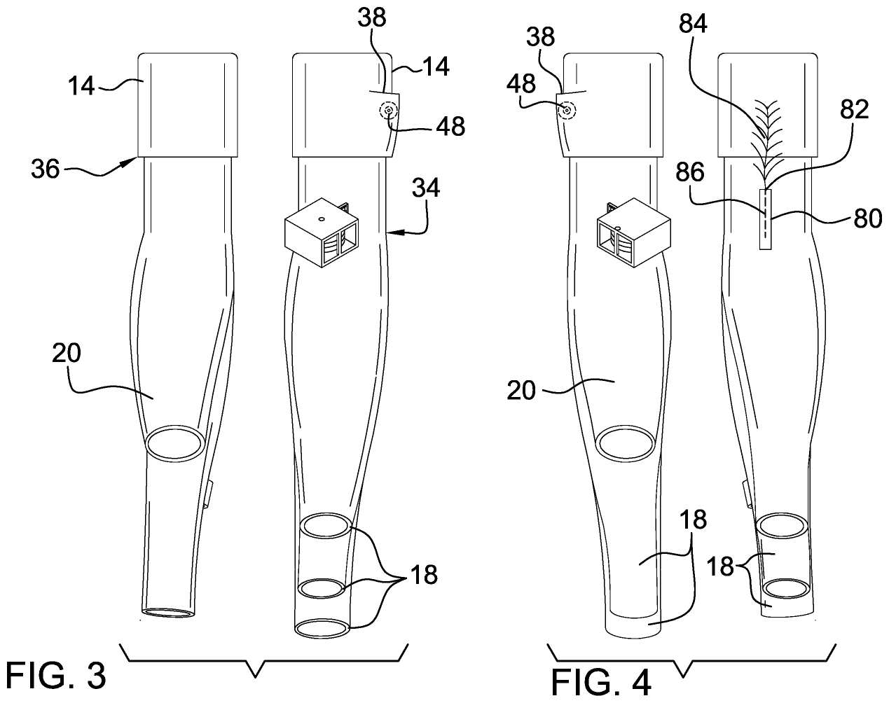

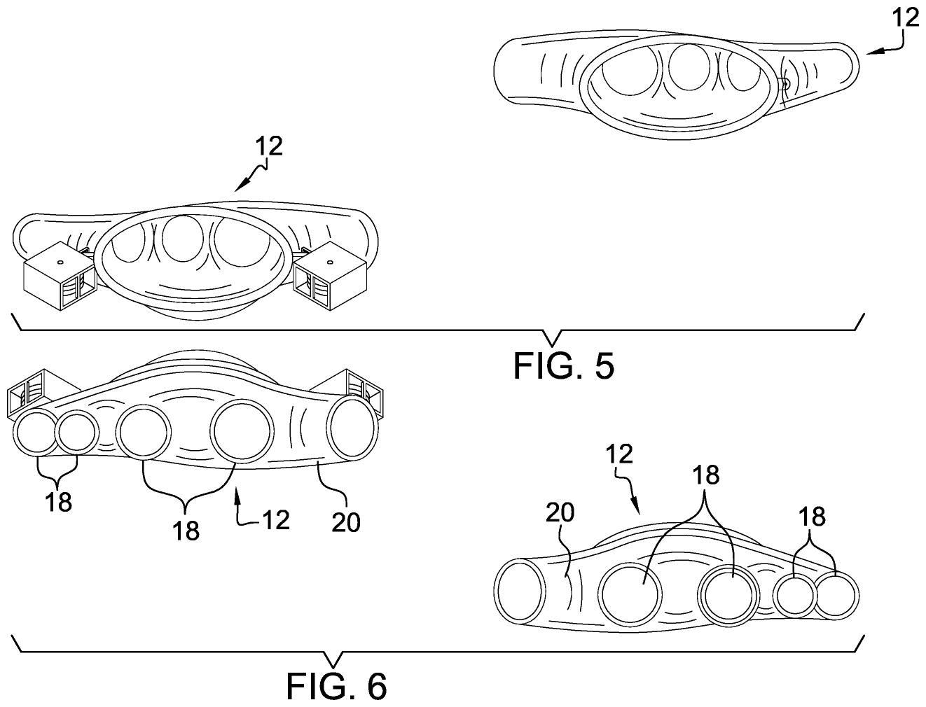

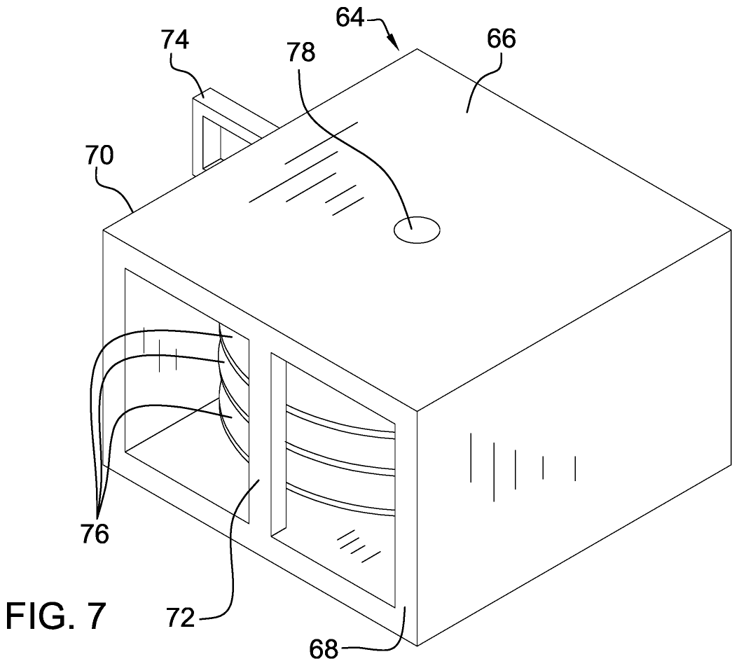

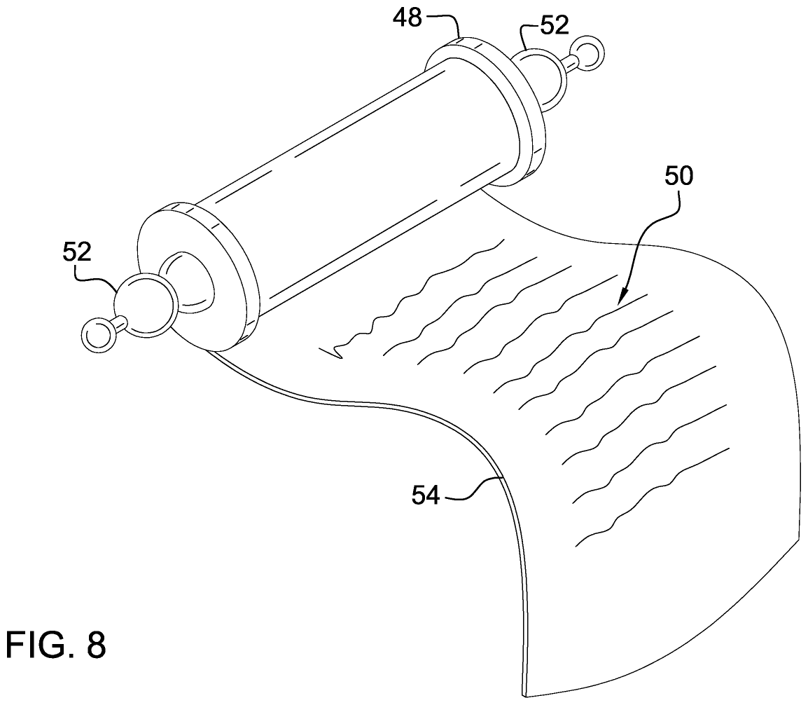

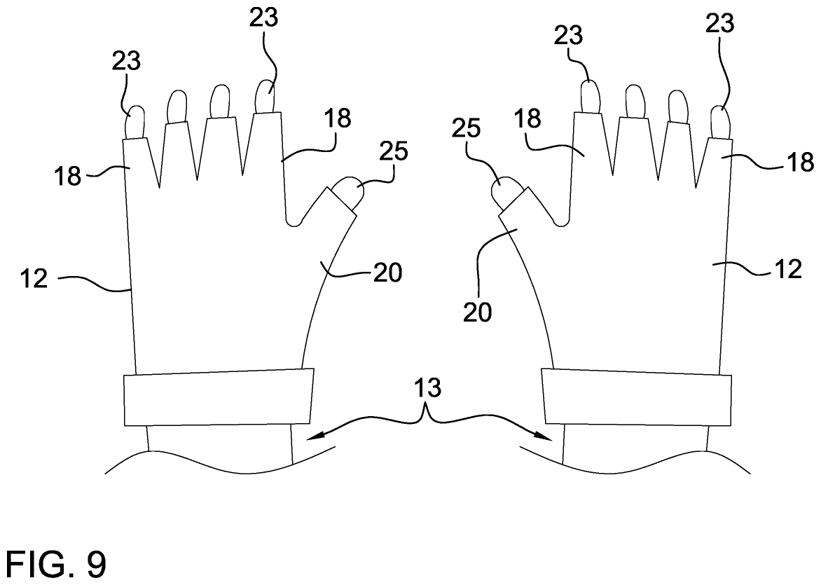

With reference now to the drawings, and in particular to FIGS. 1 through 9 thereof, a new hand garment device embodying the principles and concepts of an embodiment of the disclosure and generally designated by the reference numeral 10 will be described.

As best illustrated in FIGS. 1 through 9, the religious hand garment assembly 10 generally comprises a pair of gloves 12 that can each be worn on a respective one of a user's hands 13. Each of the gloves 12 has a cuff 14, a palm portion 16, a plurality of fingers 18 and a thumb 20. Each of the fingers 18 has a distal end 22 with respect to the palm portion 16 and the distal end 22 of each of the fingers 18 is open thereby exposing the user's fingertips 23 when the gloves 12 are worn. The thumb 20 has a distal end 24 with respect to the palm portion 16 and the distal end 24 of the thumb 20 is open thereby exposing the user's thumb tip 25 when the gloves 12 are worn.

The palm portion 16 has a top surface 26 and a bottom surface 28, and the top surface 26 of the palm portion 16 has indicia 30 printed thereon. The indicia 30 comprise words for affirming religious beliefs. The bottom surface 28 of the palm portion 16 has indicia 32 printed thereon and the indicia 32 on the bottom surface 28 comprise an image for affirming religious beliefs. The pair of gloves 12 includes a first glove 34 and a second glove 36. The cuff 14 of the first glove 34 has a cut 38 extending therethrough to access an interior of the cut 38. A middle one of the fingers 40 on the second glove 36 has a length that is less than other fingers 18 on the second glove 36.

A ring 42 is integrated around a respective one of the fingers 18 on the second glove 36. The ring 42 is aligned with the distal end 22 of the middle finger 40 on the second glove 36. The ring 42 has indicia 44 printed an outer surface 46 of the ring 42, and the indicia 44 on the outer surface 46 comprise words affirming religious beliefs. The ring 42 may be comprised of a metallic material and the ring 42 may be structured in the convention of jewelry.

A scroll 48 is rotatably integrated into a respective one of the gloves 12. The scroll 48 is pullable outwardly from the respective glove 12 such that the scroll 48 is visible. The scroll 48 has indicia 50 printed thereon comprising words for affirming religious beliefs and the scroll 48 is positioned within the cuff 14 of the first glove 34.

The scroll 48 is pullable outwardly through the cut 38 in the cuff 14 of the first glove 34. As is most clearly shown in FIG. 8, the scroll 48 may include a pair of pins 52 that is each integrated into the cuff 14 of the first glove 34. The scroll 48 may be rotatably coupled to each of the pins 52 and a length of paper 54 may be wrapped around the scroll 48. The indicia 50 associated with the scroll 48 may be printed on the length of paper 54.

A pair of brackets 56 is provided and each of the brackets 56 is coupled to a respective one of a first lateral side 58 and a second lateral side 60 of the palm portion 16 of the first glove 34. Each of the brackets 56 includes a member 62 that is spaced from the respective first lateral side 58 and the second lateral side 60. A pair of noise makers 64 is each of the noise makers 64 is movably coupled to a respective one of the gloves 12 to emit an audible sound when the respective glove 12 is shaken. Each of the noise makers 64 comprises a box 66 that has a front side 68 and a first lateral side 70. The front side 68 is open and the front side 68 has a barrier 72 extending thereacross.

An engagement 74 is coupled to the box 66 and the engagement 74 movably engages the member 62 of a respective one of the brackets 56 for movably attaching the box 66 to the respective bracket 56. A plurality of disks 76 is provided and each of the disks 76 is positioned in the box 66. The disks 76 are stacked on each other and each of the disks 76 is comprised of a metallic material to emit an audible sound when the disks 76 strike each other. A pin 78 extends through each of the disks 76 and is attached to the box 66 for movably retaining the disks 76 in the box 66.

A pouch 80 is coupled to the palm portion 16 of the second glove 36. The pouch 80 has a first end 82 that is open into an interior of the pouch 80 and the first end 82 is directed toward the cuff 14 of the second glove 36. A feather 84 is coupled to a respective one of the gloves 12 to enhance the ornamental appearance of the respective glove 12. A stem 86 of the feather 84 extends into the first end 82 of the pouch 80 having the feather 84 extending toward the cuff 14 of the second glove 36.

In use, each of the gloves 12 is worn to celebrate a religious occasion or to simply express affirmation of religious beliefs. The noise makers 64 enhance the celebratory nature of wearing the gloves 12 with the joyful noise produced by the disks 76. The scroll 48 can be pulled out of the first glove 34 to display the indicia that is printed on the scroll 48. Additionally, the feather and the ring 42 enhance the ornamental appearance of the gloves 12

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A religious hand garment assembly for facilitating a user to display religious beliefs, said assembly comprising:
a pair of gloves, each of said gloves being configured to be worn on a respective one of a user's hands;
a ring being coupled to a respective one of said gloves;
a scroll being rotatably integrated into a respective one of said gloves, said scroll being pullable outwardly from said respective glove wherein said scroll is configured to be visible;
a pair of noise makers, each of said noise makers being movably coupled to a respective one of said gloves wherein each of said noise makers is configured to emit an audible sound when said respective glove is shaken; and
a feather being coupled to a respective one of said gloves wherein said feather is configured to enhance the ornamental appearance of said respective glove.

2. The assembly according to claim 1, wherein each of said gloves has a cuff, a palm portion, a plurality of fingers and a thumb, each of said fingers having a distal end with respect to said palm portion, said distal end of each of said fingers being open wherein each of said fingers is configured to expose fingertips of the user's fingers when said gloves are worn, said thumb having a distal end with respect to said palm portion, said distal end of said thumb being open wherein said thumb is configured to expose a tip of the user's thumb when said glovers are worn.

3. The assembly according to claim 2, wherein said palm portion has a top surface and a bottom surface, said top surface of said palm portion having indicia printed thereon, said indicia comprising words for affirming religious beliefs, said bottom surface of said palm portion having indicia printed thereon, said indicia on said bottom surface comprising an image for affirming religious beliefs.

4. The assembly according to claim 2, wherein said pair of gloves includes a first glove and a second glove, said cuff of said first glove having a cut extending therethrough to access an interior of said cut, a middle one of said fingers on said second glove having a length being less than other fingers on said second glove.

5. The assembly according to claim 4, wherein said ring is integrated around said respective one of said fingers on said second glove, said ring being aligned with said distal end of said middle finger on said second glove, said ring having indicia being printed an outer surface of said ring, said indicia on said outer surface comprising words affirming religious beliefs.

6. The assembly according to claim 4, wherein said scroll has indicia being printed thereon comprising words for affirming religious beliefs, said scroll being positioned within said cuff of said first glove, said scroll being pullable outwardly through said cut in said cuff of said first glove.

7. The assembly according to claim 4, further comprising a pair of brackets, each of said brackets being coupled to a respective one of a first lateral side and a second lateral side of said palm portion of said first glove, each of said brackets including a member being spaced from said respective first lateral side and said second lateral side.

8. The assembly according to claim 7, wherein each of said noise makers comprises:
a box having a front side and a first lateral side, said front side being open, said front side having a barrier extending thereacross; and
an engagement being coupled to said box, said engagement movably engaging said member of a respective one of said brackets for movably attaching said box to said respective bracket.

9. The assembly according to claim 8, wherein each of said noise makers comprises:
a plurality of disks, each of said disks being positioned in said box, said disks being stacked on each other, each of said disks being comprised of a metallic material wherein said plurality of disks is configured to emit an audible sound when said disks strike each other; and
a pin extending through each of said disks and being attached to said box for movably retaining said disks in said box.

10. The assembly according to claim 4, further comprising a pouch being coupled to said palm portion of said second glove, said pouch having a first end being open into an interior of said pouch, said first end being directed toward said cuff of said second glove.

11. The assembly according to claim 10, further comprising a stem of said feather extending into said first end of said pouch having said feather extending toward said cuff of said second glove.

12. A religious hand garment assembly for facilitating a user to display religious beliefs, said assembly comprising:
a pair of gloves, each of said gloves being configured to be worn on a respective one of a user's hands, each of said gloves having a cuff, a palm portion, a plurality of fingers and a thumb, each of said fingers having a distal end with respect to said palm portion, said distal end of each of said fingers being open wherein each of said fingers is configured to expose fingertips of the user's fingers when said gloves are worn, said thumb having a distal end with respect to said palm portion, said distal end of said thumb being open wherein said thumb is configured to expose a tip of the user's thumb when said glovers are worn, said palm portion having a top surface and a bottom surface, said top surface of said palm portion having indicia printed thereon, said indicia comprising words for affirming religious beliefs, said bottom surface of said palm portion having indicia printed thereon, said indicia on said bottom surface comprising an image for affirming religious beliefs, said pair of gloves including a first glove and a second glove, said cuff of said first glove having a cut extending therethrough to access an interior of said cut, a middle one of said fingers on said second glove having a length being less than other fingers on said second glove;
a ring being integrated around a respective one of said fingers on said second glove, said ring being aligned with said distal end of said middle finger on said second glove, said ring having indicia being printed an outer surface of said ring, said indicia on said outer surface comprising words affirming religious beliefs;
a scroll being rotatably integrated into a respective one of said gloves, said scroll being pullable outwardly from said respective glove wherein said scroll is configured to be visible, said scroll having indicia being printed thereon comprising words for affirming religious beliefs, said scroll being positioned within said cuff of said first glove, said scroll being pullable outwardly through said cut in said cuff of said first glove;
a pair of brackets, each of said brackets being coupled to a respective one of a first lateral side and a second lateral side of said palm portion of said first glove, each of said brackets including a member being spaced from said respective first lateral side and said second lateral side;
a pair of noise makers, each of said noise makers being movably coupled to a respective one of said gloves wherein each of said noise makers is configured to emit an audible sound when said respective glove is shaken, each of said noise makers comprising:
a box having a front side and a first lateral side, said front side being open, said front side having a barrier extending thereacross;
an engagement being coupled to said box, said engagement movably engaging said member of a respective one of said brackets for movably attaching said box to said respective bracket;
a plurality of disks, each of said disks being positioned in said box, said disks being stacked on each other, each of said disks being comprised of a metallic material wherein said plurality of disks is configured to emit an audible sound when said disks strike each other; and
a pin extending through each of said disks and being attached to said box for movably retaining said disks in said box;
a pouch being coupled to said palm portion of said second glove, said pouch having a first end being open into an interior of said pouch, said first end being directed toward said cuff of said second glove; and
a feather being coupled to a respective one of said gloves wherein said feather is configured to enhance the ornamental appearance of said respective glove, a stem of said feather extending into said first end of said pouch having said feather extending toward said cuff of said second glove.
